(19) United States
(12) Patent Application Publication
(10) Pub. No.: US 2026/0219948 A1
(43) Pub. Date: Jul. 30, 2026

(54) SYSTEMS AND METHODS FOR MANAGING BATCHED ARTIFICIAL INTELLIGENCE INFERENCE REQUESTS

(71) Applicant: Dell Products L.P., Round Rock, TX (US)

(72) Inventors: Ryan N. COMER, Round Rock, TX (US); Tyler R. COX, Austin, TX (US); Marc R. HAMMONS, Round Rock, TX (US); Jarrett SIMERSON, Northbrook, IL (US)

(73) Assignee: Dell Products L.P., Round Rock, TX (US)

(21) Appl. No.: 19/037,505

(22) Filed: Jan. 27, 2025

(51) Int. Cl. G06F 9/50

(52) U.S. Cl. CPC G06F 9/5038

(57) ABSTRACT

An information handling system may include a memory and a processor communicatively coupled to the memory, and configured to receive a synchronous inference request, select a compute node for execution of the synchronous inference request, and determine if the synchronous inference request fills an execution batch of the compute node. The processor may also be configured to, if the synchronous inference request fills the execution batch, cause the compute node to execute the synchronous inference request in the execution batch. The processor may further be configured to, if the synchronous inference request fails to fill the execution batch, select at least one second inference request for execution, and cause the compute node to execute the synchronous inference request and the at least one second inference request in the execution batch.

### TECHNICAL FIELD

The present disclosure relates in general to information handling systems, and more particularly to methods and systems for managing batched artificial intelligence inference requests.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems are increasingly used for artificial intelligence. Artificial intelligence, in its broadest sense, is intelligence exhibited by machines, particularly information handling systems. Artificial intelligence is a field of research in computer science that develops and studies methods and software that enable machines to perceive their environment and use learning and intelligence to take actions that maximize their chances of achieving defined goals. Artificial intelligence models are executable programs that detect specific patterns using a collection of data sets. A model may be thought of as an illustration of a system that can receive data inputs and draw conclusions or conduct actions depending on those conclusions. An example of an artificial model is a neural network, which may be a model that makes decisions in a manner similar to the human brain, by using processes that mimic the way biological neurons work together to identify phenomena, weigh options and arrive at conclusions.

As advancements in artificial intelligence infrastructure continue to enable more client-friendly form factors, artificial intelligence model deployments are rapidly diversifying from cloud computing environments to edge computing environments. Artificial intelligence-enabled enterprises have increasingly more freedom to choose where their workloads run, often selecting local and edge deployments for the sake of cost and data protection. However, edge environments present unique challenges.

When an inference request is handled by a compute platform, the compute platform may perform the neural network operations defined by the layers of the model. Depending on the capabilities of the compute platform and the architecture of the model, some of the potential throughput can be lost. This loss occurs when the size of the input batch is much smaller than the maximum batch size that the compute platform can handle. Neural network operations are performed on the entire batch regardless of input size, and any unused space may be effectively wasted. Accordingly, systems and methods that maximize throughput for inference requests are desired.

### SUMMARY

In accordance with the teachings of the present disclosure, the disadvantages and problems associated with existing approaches to processing of batched artificial intelligence inference requests may be reduced or eliminated.

In accordance with embodiments of the present disclosure, an information handling system may include a memory and a processor communicatively coupled to the memory, and configured to receive a synchronous inference request, select a compute node for execution of the synchronous inference request, and determine if the synchronous inference request fills an execution batch of the compute node. The processor may also be configured to, if the synchronous inference request fills the execution batch, cause the compute node to execute the synchronous inference request in the execution batch. The processor may further be configured to, if the synchronous inference request fails to fill the execution batch, select at least one second inference request for execution, and cause the compute node to execute the synchronous inference request and the at least one second inference request in the execution batch.

In accordance with these and other embodiments of the present disclosure, a method may include receiving a synchronous inference request, selecting a compute node for execution of the synchronous inference request, and determining if the synchronous inference request fills an execution batch of the compute node. The method may also include if the synchronous inference request fills the execution batch, causing the compute node to execute the synchronous inference request in the execution batch. The method may further include if the synchronous inference request fails to fill the execution batch, selecting at least one second inference request for execution, and causing the compute node to execute the synchronous inference request and the at least one second inference request in the execution batch.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to: receive a synchronous inference request; select a compute node for execution of the synchronous inference request; determine if the synchronous inference request fills an execution batch of the compute node; if the synchronous inference request fills the execution batch, cause the compute node to execute the synchronous inference request in the execution batch; and if the synchronous inference request fails to fill the execution batch, select at least one second inference request for execution, and cause the compute node to execute the synchronous inference request and the at least one second inference request in the execution batch.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system for executing artificial intelligence workloads, in accordance with embodiments of the present disclosure;

FIGS. 2A and 2B (which may collectively be referred to herein as FIG. 2) illustrate a flow chart of an example method for managing batched artificial intelligence inference requests, in accordance with embodiments of the present disclosure;

FIG. 3 illustrates a block diagram of placement of asynchronous inference requests to fill a batch, in accordance with embodiments of the present disclosure; and

FIG. 4 illustrates a block diagram of duplication of synchronous inference requests to fill a batch, in accordance with embodiments of the present disclosure.

### DETAILED DESCRIPTION

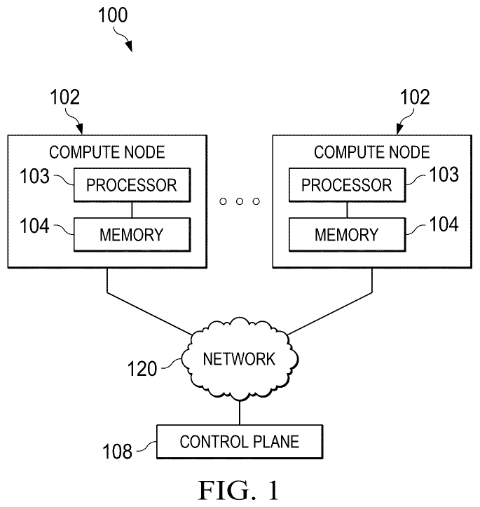

Preferred embodiments and their advantages are best understood by reference to FIGS. 1 through 4, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example system 100 for executing artificial intelligence workloads, in accordance with embodiments of the present disclosure. As shown in FIG. 1, system 100 may include a plurality of compute nodes 102, a control plane 108, and a network 120.

Each compute node 102 may comprise an information handling system, as defined above. In operation, each compute node 102 may be configured to execute an artificial intelligence workload using the processing and memory resources thereof. The various compute nodes 102 in system 100 may represent different types of information handling systems within an enterprise. For example, one or more of compute nodes 102 may comprise servers, one or more of compute nodes 102 may comprise client information handling systems (e.g., a laptop, notebook, tablet, handheld, smart phone, personal digital assistant, etc.), one or more of compute nodes 102 may comprise edge devices, and one or more of compute nodes 102 may comprise cloud computing resources.

As depicted in FIG. 1, each compute node 102 may include a processor 103, and a memory 104 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), graphics processing unit (GPU), neural processing unit (NPU), or any other digital or analog circuitry configured to interpret and/or execute program instructions and/or process data. In some embodiments, processor 103 may interpret and/or execute program instructions and/or process data stored in memory 104 and/or another component of a compute node 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to compute node 102 is turned off.

In operation, memory 104 may store all or a portion of an artificial intelligence model, data associated with the model, and executable instructions which may be read and executed by processor 103 to process the data in accordance with the model.

For purposes of clarity and exposition, each compute node 102 is depicted as only including a processor 103 and a memory 104. However, each compute node 102 may comprise other information handling resources not explicitly depicted in FIG. 1.

Control plane 108 may comprise any system, device, or apparatus configured to manage and control execution of artificial intelligence models on the various compute nodes 102. Accordingly, control plane 108 may execute one or more services, including an orchestrator service, for assisting the placement of artificial intelligence workloads for execution among the various compute nodes 102, as described in greater detail below. In some embodiments, control plane 108 may comprise an information handling system distinct from compute nodes 102. In other embodiments, control plane 108 may be a part of and/or executed by one of compute nodes 102. Although not shown in FIG. 1, control plane 108 may also include a processor (e.g., similar to processor 103), memory (e.g., similar to memory 104) and other information handling resources.

Network 120 may comprise a network and/or fabric configured to communicatively couple compute nodes 102 and control plane 108 to each other and/or one or more other information handling systems. In these and other embodiments, network 120 may include a communication infrastructure, which provides physical connections, and a management layer, which organizes the physical connections and information handling systems communicatively coupled to network 120. Network 120 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 120 may transmit data via wireless transmissions and/or wire-line transmissions using any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 120 and its various components may be implemented using hardware, software, or any combination thereof.

In operation, control plane 108 may implement an inference request manager to maximize an amount of throughput for every inference request handled by a compute node 102. Such inference request manager may ensure the full batch size of a compute node is utilized on each inference request. Asynchronous inference requests may be sent by clients to the request manager and may be performed alongside synchronous inference requests if there is additional room in the input batch of the compute node. The inference request manager may use attributes such as priority and deadlines of the asynchronous interference requests, as well as communicating forecast priority levels to clients to solicit further asynchronous queue depth or synchronous request parallelism level and prevent underruns. Additionally, if there are no asynchronous inference requests in a queue, then the inference request manager may duplicate an input set to fill out the remaining batch space, which may lead to multiple inference output options returned to the requesting client, due to model generation variance. Accordingly, the cumulative throughput of a compute node may be maximized without incurring any additional power or compute costs.

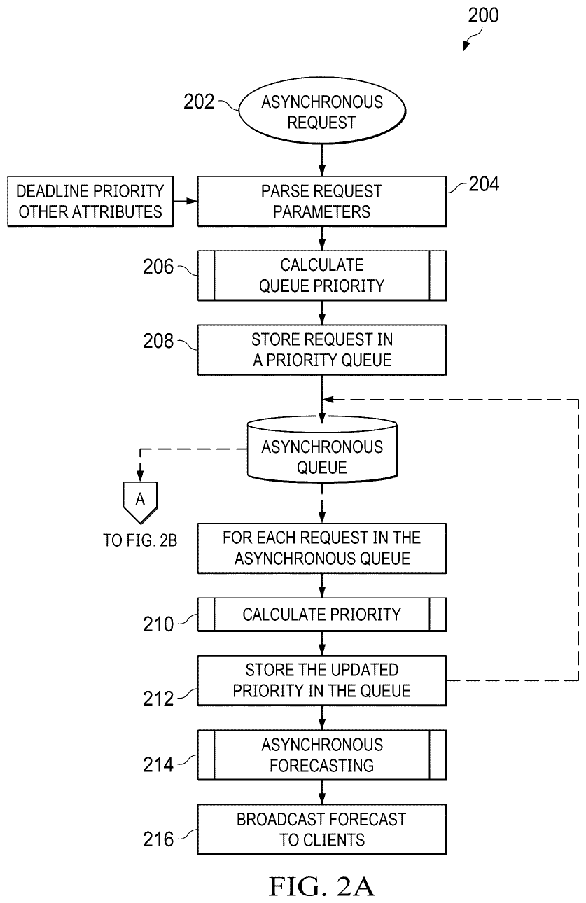

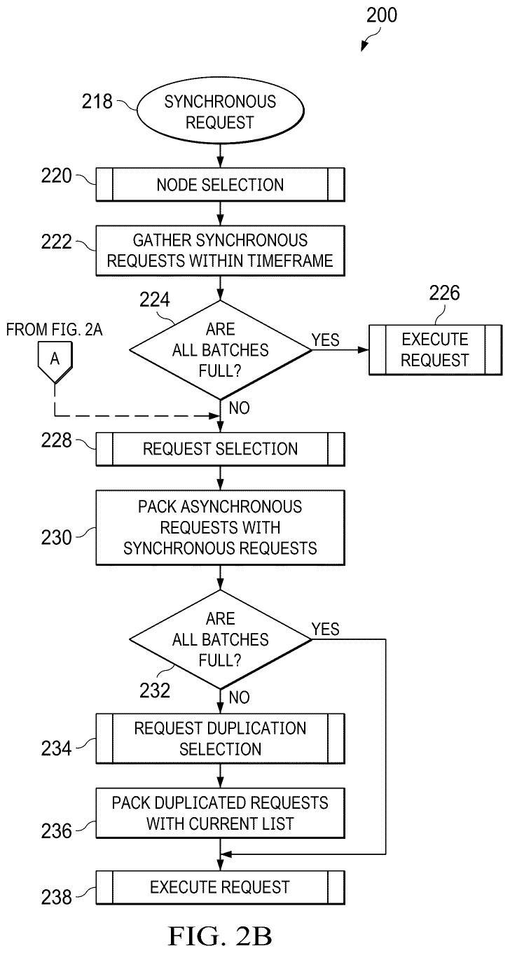

FIG. 2 illustrates a flow chart of an example method 200 for managing batched artificial intelligence inference requests, in accordance with embodiments of the present disclosure. According to some embodiments, method 200 may begin at step 202. As noted above, teachings of the present disclosure may be implemented in a variety of configurations of system 100. As such, the preferred initialization point for method 200 and the order of the steps comprising method 200 may depend on the implementation chosen.

At step 202, an inference request manager of control plane 108 may receive an asynchronous inference request. At step 204, the inference request manager may receive attributes associated with the asynchronous inference request and parse parameters of the asynchronous inference request. At step 206, based on such attributes and parameters, the inference request manager may calculate a queue priority for the asynchronous inference request. At step 208, the inference request manager may store the asynchronous inference request in an asynchronous priority queue. Steps 202 through 208 may repeat as necessary for each asynchronous inference request received.

On a periodic basis, for each asynchronous inference request in the asynchronous priority queue, inference request manager may perform steps 210-216. At step 210, the inference request manager may calculate the priority of each asynchronous inference request and store the updated priority in the asynchronous priority queue at step 212. At step 214, the inference request manager may perform an inference request forecast, and at step 216 broadcast the inference request forecast to clients of system 100, in order to solicit further asynchronous priority queue depth.

At step 218, the inference request manager may receive a synchronous inference request. At step 220, the inference request manager may select a compute node 102 for execution of the synchronous inference request. At step 222, the inference request manager may gather all synchronous inference requests to be executed by the selected compute node 102 within a defined timeframe. At step 224, the inference request manager may determine if all batches of the selected compute node 102 are full. If all batches of the selected compute node 102 are full, method 200 may proceed to step 226. Otherwise, method 200 may proceed to step 228.

At step 226, the inference request manager may execute the request on the selected compute node 102 with the batches full of synchronous inference requests.

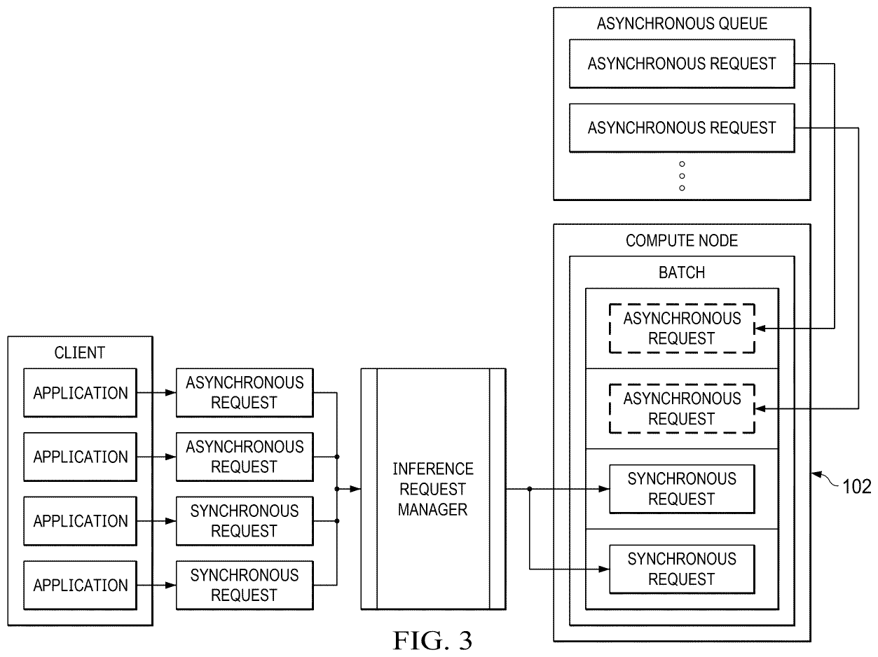

At step 228, the inference request manager may begin a request selection process in order to fill the batches of the selected compute node 102. As part of such process, at step 230, the inference request manager may, based on priorities of asynchronous inference requests in the asynchronous priority queue, select asynchronous inference requests and pack such selected asynchronous inference requests with the synchronous inference requests, as illustrated in FIG. 3. As shown in FIG. 3, in response to synchronous inference requests and asynchronous inference requests by a client, the inference request manager may pack the execution batch of compute node 102 with synchronous inference requests and asynchronous inference requests selected from the asynchronous priority queue in order to maximize cumulative throughput of compute node 102.

At step 232, the inference request manager may again determine if all batches of the selected compute node 102 are full. If all batches of the selected compute node 102 are full, method 200 may proceed to step 238. Otherwise, method 200 may proceed to step 234.

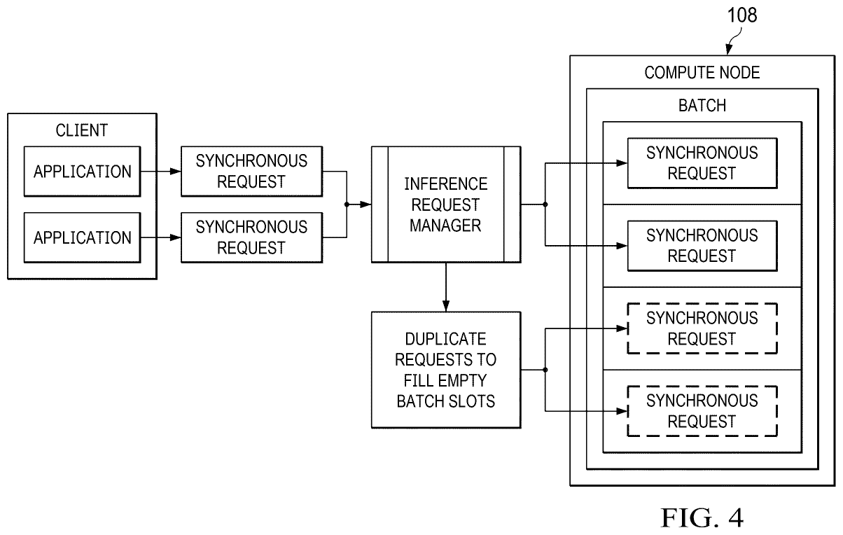

At step 234, the inference request manager may select one or more duplicate requests of synchronous inference requests in order to fill the batches of the selected compute node 102. At step 236, the inference request manager may pack such selected duplicate synchronous inference requests with the synchronous inference requests (and any asynchronous inference requests also selected), as illustrated in FIG. 4. As shown in FIG. 4, in response to synchronous inference requests by a client, the inference request manager may pack the execution batch of compute node 102 with synchronous inference requests and duplicate synchronous inference requests in order to maximize cumulative throughput of compute node 102.

At step 238, the inference request manager may execute the request on the selected compute node 102 with the synchronous inference requests, along with the selected asynchronous inference requests and/or selected duplicate synchronous inference requests.

Steps 218 through 238 may repeat as necessary for each synchronous inference request received.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a memory; and
a processor communicatively coupled to the memory, and configured to:
receive a synchronous inference request;
select a compute node for execution of the synchronous inference request;
determine if the synchronous inference request fills an execution batch of the compute node;
if the synchronous inference request fills the execution batch, cause the compute node to execute the synchronous inference request in the execution batch; and
if the synchronous inference request fails to fill the execution batch, select at least one second inference request for execution, and cause the compute node to execute the synchronous inference request and the at least one second inference request in the execution batch.

2. The information handling system of claim 1, wherein the at least one second inference request comprises a second synchronous inference request.

3. The information handling system of claim 1, wherein the at least one second inference request comprises a second synchronous inference request and an asynchronous inference request.

4. The information handling system of claim 1, wherein the at least one second inference request comprises an asynchronous inference request.

5. The information handling system of claim 4, wherein the asynchronous inference request is selected based on a priority of the asynchronous inference request as compared to one or more priorities of other asynchronous inference requests.

6. The information handling system of claim 5, wherein the priority is based on attributes of the asynchronous inference request.

7. The information handling system of claim 5, the processor further configured to:
generate a forecast for priority levels of asynchronous inference requests; and
communicate the forecast to one or more client information handling systems.

8. A method comprising:
receiving a synchronous inference request;
selecting a compute node for execution of the synchronous inference request;
determining if the synchronous inference request fills an execution batch of the compute node;
if the synchronous inference request fills the execution batch, causing the compute node to execute the synchronous inference request in the execution batch; and
if the synchronous inference request fails to fill the execution batch, selecting at least one second inference request for execution, and causing the compute node to execute the synchronous inference request and the at least one second inference request in the execution batch.

9. The method of claim 8, wherein the at least one second inference request comprises a second synchronous inference request.

10. The method of claim 8, wherein the at least one second inference request comprises a second synchronous inference request and an asynchronous inference request.

11. The method of claim 8, wherein the at least one second inference request comprises an asynchronous inference request.

12. The method of claim 11, wherein the asynchronous inference request is selected based on a priority of the asynchronous inference request as compared to one or more priorities of other asynchronous inference requests.

13. The method of claim 12, wherein the priority is based on attributes of the asynchronous inference request.

14. The method of claim 12, further comprising:
generating a forecast for priority levels of asynchronous inference requests; and
communicating the forecast to one or more client information handling systems.

15. An article of manufacture comprising:
a non-transitory computer-readable medium; and
computer-executable instructions carried on the computer-readable medium, the instructions readable by a processor, the instructions, when read and executed, for causing the processor to:
receive a synchronous inference request;
select a compute node for execution of the synchronous inference request;
determine if the synchronous inference request fills an execution batch of the compute node;
if the synchronous inference request fills the execution batch, cause the compute node to execute the synchronous inference request in the execution batch; and
if the synchronous inference request fails to fill the execution batch, select at least one second inference request for execution, and cause the compute node to execute the synchronous inference request and the at least one second inference request in the execution batch.

16. The article of claim 15, wherein the at least one second inference request comprises a second synchronous inference request.

17. The article of claim 15, wherein the at least one second inference request comprises a second synchronous inference request and an asynchronous inference request.

18. The article of claim 15, wherein the at least one second inference request comprises an asynchronous inference request.

19. The article of claim 18, wherein the asynchronous inference request is selected based on a priority of the asynchronous inference request as compared to one or more priorities of other asynchronous inference requests.

20. The article of claim 19, wherein the priority is based on attributes of the asynchronous inference request.

21. The article of claim 19, the processor further configured to:
generate a forecast for priority levels of asynchronous inference requests; and
communicate the forecast to one or more client information handling systems.
